(19) United States
(12) Patent Application Publication
(10) Pub. No.: US 2015/0361883 A1
(43) Pub. Date: Dec. 17, 2015

(54) GAS TURBINE PLANT WITH IMPROVED FLEXIBILITY

(71) Applicant: SIEMENS AKTIENGESELISCHAFT, München (DE)

(72) Inventors: Uwe Lenk, Zwickau (DE); Alexander Tremel, Erlangen (DE)

(73) Assignee: SIEMENS AKTIENGESELLSCHAFT, Munich (DE)

(21) Appl. No.: 14/761,942

(22) PCT Filed: Jan. 14, 2014
(86) PCT No.: PCT/EP2014/050600

§ 371 Date: Jul. 18, 2015

(30) Foreign Application Priority Data
Jan. 23, 2013 (EP) 13152401.9

(51) Int. Cl. F02C 3/30; F01K 23/10

(52) U.S. Cl. CPC F02C 3/305; F01K 23/10

(57) ABSTRACT

A gas turbine plant includes a gas turbine having a compressor, a combustion chamber and an expander; and a water-steam circuit which is thermally connected to the gas turbine such that during the operation of the gas turbine, waste gas drawn off therefrom transfers heat to the water-steam circuit in order to generate steam. The water-steam circuit is further thermally connected to a heat accumulator which in turn is thermally connected to a container for storing water. The container is fluidically coupled to the gas turbine such that water can be supplied from the container to the gas turbine during the operation of the latter in order to increase output. A flash valve is connected between the container and the gas turbine, the valve being designed to reduce the pressure of the water taken from the container to a lower pressure level.

### CROSS REFERENCE TO RELATED APPLICATIONS

This application is the US National Stage of International Application No. PCT/EP2014/050600 filed Jan. 14, 2014, and claims the benefit thereof. The International Application claims the benefit of European Application No. EP13152401 filed Jan. 23, 2013. All of the applications are incorporated by reference herein in their entirety.

### FIELD OF INVENTION

The present invention relates to a gas turbine plant comprising a gas turbine, which has a compressor, a combustion chamber and an expander, further comprising a water-steam circuit which is thermally connected to the gas turbine in such a way that, during the operation of said gas turbine, the waste gas discharged therefrom transfers heat to the water-steam circuit in order to generate steam. The present invention furthermore relates to a method for flexible operation of a gas turbine plant of this kind.

### BACKGROUND OF INVENTION

Owing to increasing power input into public power supply networks from sometimes greatly fluctuating renewable energy sources (wind energy, solar energy etc.), gas power plants are increasingly being used for regulation in order to ensure the network stability of these power supply networks.

Here, as in all the following embodiments, the term “gas power plants” should be taken in its most general meaning. In particular, these include both conventional gas power plants operating in simple-cycle mode and coupled gas and steam power plants. These can furthermore also include large-scale plants that can be supplied with electrical energy by a gas turbine. There is likewise no intention to impose a restriction as regards the fuel for combustion in the gas power plant. It is therefore possible, for example, for a gas power plant to be operated with natural gas or to connect to its input a system for thermal gasification of solids (Integrated Gasification Combined Cycle IGCC) to provide a fuel supply.

Owing to the regulating function assigned to gas power plants, they must be capable of being operated with increased flexibility. At the same time, they must also meet the requirements of economical operation. In this context, the degree of utilization of a gas power plant and hence also the life of such a power plant falls, particularly due to relatively irregular power operation with frequent startup and shutdown processes. Sometimes, therefore, there is a significant negative effect on the economy of operation.

Conventional operation of a gas turbine plant with greater flexibility is made possible, for instance, by suitable setting of the operating load in a range of about 40 to 100% of the achievable rated load. For this purpose, the fuel mass flow is typically reduced or increased and, if appropriate, suitable adjustment of the guide vanes on the compressor of the gas turbine can also be performed in order to adapt the fuel mass flow and to operate the plant at a suitably adapted part load.

Typically, increasing the operating load beyond 100% of the rated load is not possible or not envisaged. However, such an increase can sometimes be made possible by suitable injection of water into the gas turbine. For this purpose, depending on the technological embodiment, water in the liquid or, preferably, as an alternative, in the vapor phase can be added to the gas turbine at different points during operation in order, in particular, to achieve an increased mass flow and thus obtain increased power. It is likewise also possible to introduce water in the liquid or, preferably, in the vapor phase into the compressor of the gas turbine, wherein the water ensures improved cooling of the compressed air and hence the compressor has to perform less compression work. Various modes of operation in which an increased power output is made possible by introducing water into the gas turbine are known from the literature (e.g.: Jonsson, M., Yan, J.: Humidified gas turbines—a review of proposed and implemented cycles, Energy 30 (2005), 1013-1078).

Through water or steam injection into the gas turbine, the mass flow through the expander (turbine) increases, thereby increasing the power output in the expander through gas expansion. This water or steam injection into the gas turbine is also known as the STIG concept “Steam Injection Gas Turbine Cycle”). Another embodiment is the Cheng cycle. Moreover, operation in this way also has the advantage that the nitrogen oxides which form during combustion form only at a relatively low concentration, with the result that the exhaust gases from the gas turbine have a lower potential for environmental damage.

However, the disadvantage with these concepts known from the prior art is that the quantities of water fed to the gas turbine in liquid or gaseous form have to be conditioned thermally in advance, entailing an additional outlay on processing. Moreover, it has to be ensured that the water is also suitably processed in respect of chemical and physical impurities. Both forms of processing cause an increased expenditure of energy, which reduces the overall power balance of gas turbine operation. Moreover, suitable structural and servicing measures have to be provided according to the concepts known from the prior art in order to make such feeding of water to a gas turbine largely problem-free during the time of regular operation.

Initial approaches to solving these technical problems can be proposed by DE19918346A1, which teaches providing a gas turbine plant comprising a water-steam circuit with a container as a heat accumulator. The container is filled with water or steam, which can be charged up thermally through thermal interaction with a heat recovery boiler in the water-steam circuit. When there is a demand for a power increase, water or steam can be injected into the combustion chamber or other parts of the gas turbine included in the gas turbine plant in order to increase mass flow.

However, the disadvantage with this technical embodiment is that the water which is supplied to the gas turbine can sometimes contain liquid water components, which can lead to massive damage to the internal components of the gas turbine. This is particularly the case also when the gas turbine is supposed to be supplied exclusively with liquid water. However, the temporary storage of liquid water is advantageous since it allows larger quantities of energy to be stored in a smaller volume than that with steam storage at the same temperature level. Thus, this reduces the outlay on construction and costs as well as operating costs. If the intention is to store liquid water in the container, DE19918346A1 proposes to open this container to a larger system and to operate the container as a variable pressure accumulator. However, this ensures a significant energy loss since the water is depressurized in the entire container and significant proportions of the energy are unused and lost. Moreover, the steam pressure cannot be set with sufficient accuracy and on an individual basis since it is dependent on the pressure conditions of the larger system.

U.S. Pat. No. 5,404,708 is also incapable of providing any suggestions for a better technical solution in this regard since, there too, only liquid water is held in an accumulator, from which this water can then be taken without further processing when required in order to supply it to a gas turbine.

### SUMMARY OF INVENTION

It is thus an underlying object of the present invention to avoid the disadvantages known from the prior art and to propose an improved water supply to the gas turbine of a gas turbine plant. In particular, the invention is intended to ensure that the flexibility of the gas turbine plant is improved, wherein the intention is that it should also be possible to store water in liquid form, which can be added to a gas turbine when required to increase the power, without the risk, however, of damage to internal components of the gas turbine due to droplet formation.

At the same time, such operation should also be possible in an advantageous way in terms of energy.

According to the invention, these objects underlying the invention are achieved by a gas turbine plant and by a method for the flexible operation of such a gas turbine plant as claimed.

In particular, these objects underlying the invention are achieved by a gas turbine plant which comprises the following: a gas turbine, which has a compressor, a combustion chamber and an expander, further comprising a water-steam circuit which is thermally connected to the gas turbine in such a way that, during the operation of said gas turbine, the waste gas discharged therefrom transfers heat to the water-steam circuit in order to generate steam, wherein the water-steam circuit is further thermally connected to a heat accumulator, which in turn is thermally connected to a container for storing water, and wherein the container is fluidically coupled to the gas turbine, in particular to the combustion chamber of the gas turbine, in such a way that water can be supplied from the container to the gas turbine during the operation of the latter in order to increase power output, wherein a flash valve is connected between the container and the gas turbine, said valve being designed to reduce the pressure of the water taken from the container to a lower pressure level.

The objects underlying the invention are furthermore achieved by a method for the flexible operation of a gas turbine plant in accordance with one of the embodiments described above and below, which method comprises the following:—operating the gas turbine and discharging the exhaust gas from the latter and transferring heat to the water-steam circuit for steam generation;—transferring heat from the water-steam circuit to the heat accumulator;—transferring heat from the heat accumulator to the container;—transferring water from the container to the gas turbine, in particular to the combustion chamber of the gas turbine, to increase power during operation of the gas turbine.

According to aspects of the invention, it is therefore possible to extract heat or even water from the water-steam circuit and to feed it to a heat accumulator, which is thermally connected to the water-steam circuit. Here, the heat or water is stored temporarily in the heat accumulator and can advantageously be extracted at a later time in order, namely, to thermally process or have processed water, for instance, which is then fed to the gas turbine to increase the power during operation.

The water concerned is situated in a container, which is thermally or even fluidically connected to the heat accumulator. To this extent, the heat can advantageously be transferred from the heat accumulator to the container. For its part, the container can now contain water of suitable quality, with the result that there is no longer a need for any further physical and chemical processing of this water before it is fed to the gas turbine to increase the power during operation. This water is advantageously taken from other power plant processes, and therefore there is no longer a need for any additional processing. The water stored in the container is sometimes conditioned only thermally, wherein the heat required for processing can be extracted from the water-steam circuit, for example.

It is likewise possible, as will be explained below, that the heat accumulator comprises the container for storing water, making it possible to feed water directly from the water-steam circuit into the container of the heat accumulator. Accordingly, less outlay in terms of construction is also required. As an alternative or in addition, the heat accumulator can also be thermally coupled to the container for storing water by means of suitable heat exchangers, allowing suitable heat exchange to take place without, however, the occurrence of fluid transfer.

The present invention thus makes possible the temporary storage of heat from the water-steam circuit and extraction of this heat from the heat accumulator at a later time, e.g. when the gas turbine plant undergoes a higher power owing to increased demand from the public power supply networks. There is thus an improvement in the flexibility of use of the gas turbine plant. However, this affects not only the flexibility of the gas turbine plant in terms of time but also flexibility in terms of energy since, in particular, the tapping of thermal energy from the water-steam circuit in small quantities, as will be explained further below, does not lead to a significant loss of power during power generation by the gas turbine plant.

According to another aspect of the invention, it is envisaged that a flash valve is connected between the container and the gas turbine, said valve being designed to reduce the pressure of the water taken from the container to a lower pressure level. In particular, the flash valve is designed to separate out steam in order to feed the latter selectively to the gas turbine without a liquid component, likewise separated out, of the water which has been depressurized in this way. During the depressurization of liquid and thermally treated water via a flash valve, the pressure level is lowered, wherein partial evaporation and cooling occurs. By means of the depressurization, steam is made available at a relatively low pressure level. The water in the liquid phase which is separated out during this process can be mixed with make-up water, for example, and then pumped, by means of a pump for example, into a receiving tank, which can once again be at a higher pressure level. Consequently, it is also possible to store liquid and thermally treated water in the container according to the invention without the risk that damage due to droplet formation will occur when added to the gas turbine. At the same time, thermal energy can be stored in a significantly smaller container volume than that for steam storage, said volume having a lower energy density at the same temperature.

The invention thus makes possible improved flexibility of a gas turbine plant while using conventional components and manageable method steps. An expansion of the power and efficiency range of the gas turbine plant is thereby made possible, since the power reduction can be accomplished by steam extraction, for instance, as can a power increase, given appropriate addition of water to the gas turbine. Particularly in the case of a power increase due to the supply of water to the gas turbine, the part load efficiency can thus also be improved.

It is likewise also possible to enable a reduction in fuel consumption while maintaining the same electric output power from the gas turbine plant for instance, if water is fed to the gas turbine to increase the power for instance. By means of a time-delayed extraction of thermal energy from the heat accumulator, in particular, it is possible even then to supply more power from the gas turbine plant at some other time, namely when the gas turbine plant has to provide increased regulating power for instance. It should be noted here that, when water is fed to the gas turbine to increase the power during operation, peak load generation significantly above the rated load of 100% is achievable.

According to a first embodiment of the invention, it is envisaged that the heat accumulator comprises or is the container. To this extent, water at the prevailing pressure and temperature level can be extracted from the water-steam circuit, for example, wherein this water is transferred directly into the container for temporary storage. As a very particular option, transfer takes place at increased pressure above the pressure required at the feed-in location of the gas turbine. In the simplest design case, the heat accumulator can also be replaced by the container. If, during subsequent use, the gas turbine of the gas turbine plant then has to provide increased power, the water can be taken from the container, being fed to the gas turbine of the gas turbine plant in a suitable form to increase the power.

Accordingly, the water carried in the water-steam circuit can be made available directly to the gas turbine to increase the power after suitable temporary storage. However, owing to the high process requirements, the water in the water-steam circuit also has a high and therefore sufficient purity to be fed to a gas turbine to increase the power. Thus, the water temporarily stored in the container does not require any further purification steps before it can be fed directly to the gas turbine. This, in turn, reduces the number of energy-intensive steps for purification and thermal treatment. This is particularly advantageous. Furthermore, this embodiment also reduces the number of components required by the construction, wherein the investment for providing this form according to the invention of the gas turbine plant can be reduced in comparison with other forms. Moreover, it proves particularly advantageous that the water extracted from the water-steam circuit already has a suitable conditioning, both thermally and pressure-wise as regards the pressure level, with the result that the transfer of water from the container to the gas turbine also no longer requires any further pressure treatment. Once again, this too is particularly advantageous.

According to another particularly advantageous embodiment of the invention, the water-steam circuit comprises a heat recovery steam generator, which is connected thermally and fluidically to the heat accumulator. It should be noted here that the fluidic connection also results in a thermal connection since the fluid containing thermal energy can be exchanged in a suitable way. The thermal and the fluidic connection can advantageously take place in the region of a medium-pressure section (typical pressure range 15-40 bar, referred to as the medium-pressure level) or a high-pressure section (typical pressure range over 70 bar, referred to as the high-pressure level) of the heat recovery steam generator. For this purpose, heat or fluid extracted from the medium-pressure section or the high-pressure section can be transferred in a suitable way into the heat accumulator or container, ensuring that heat or fluid is available at a suitable pressure or temperature level.

At this point it may also be pointed out that, unless otherwise stated, the fluid described above is water in its naturally occurring physical phases. In this case, it is either liquid water, water in the form of steam or some other states of aggregation which is/are present, depending on the temperature and pressure level.

According to another embodiment of the invention, it is envisaged that the water-steam circuit has a steam turbine, which is connected thermally and fluidically to the heat accumulator. Particularly if the steam turbine has a set of individual turbines operated at different pressure levels and at different temperatures. According to such an embodiment, it is then found to be advantageous to tap water at a suitable pressure level and a suitable temperature off from the steam turbine or from the individual turbines in order to extract heat from it or in order to store it for subsequent feeding to the gas turbine to increase the power. Particularly when water is tapped off in the region of a medium-pressure turbine, the water has a suitable pressure and temperature level which make it appear particularly advantageous to feed the water extracted directly to the gas turbine to increase the power after temporary storage.

According to another advantageous aspect of the invention, it is envisaged that the water-steam circuit and the heat accumulator are connected not only thermally but also fluidically. An exchange of fluid thus also simultaneously allows a simple exchange of heat, as already explained above. Fluidic connection is thus particularly advantageous in terms of design.

According to a development of this embodiment, it is envisaged that water exchanged between the water-steam circuit and the heat accumulator can be stored temporarily in the container. This allows extraction of water purified as already explained above from the water-steam circuit, which water no longer requires additional expensive treatment for the time-delayed subsequent feeding of the water to the gas turbine to increase the power. On the contrary, the water extracted from the water-steam circuit can be temporarily stored for a time in the container and, when an increase in power is required, the water can be fed directly to the gas turbine in suitable quantities and under suitable physical conditions.

Likewise in the sense of a development or an alternative embodiment, it is also possible to envisage that the fluidic connection between the water-steam circuit and the heat accumulator at the water-steam circuit is produced at a location at which the steam pressure prevailing during regular operation of the gas turbine plant corresponds at least to the pressure in the combustion chamber of the gas turbine during regular operation. In particular, this extraction pressure in the water-steam circuit is 5 to 35 bar, wherein the combustion chamber pressure in the combustion chamber is lower if the water is fed to the gas turbine via the combustion chamber. A typical pressure range of 4 to 20 bar can prevail in the combustion chamber during the operation of the gas turbine. According to the embodiment, therefore, the water extracted from the water-steam circuit has a higher pressure than or at least the same pressure as the pressure prevailing in the combustion chamber of the gas turbine. The water fed to the gas turbine to increase the power thus no longer has to be treated pressure-wise. Moreover, injection of the water present at such a pressure level into the combustion chamber of the gas turbine in a manner which is particularly advantageous in terms of energy can be achieved. If the pressure at which the water extracted from the water-steam circuit is stored in the container is significantly higher than, for instance, the combustion chamber pressure of the combustion chamber of the gas turbine, storage of the water temporarily stored in this way over a relatively long time may also be possible without the need for energy-intensive pressure conditioning, even in the case of subsequent feeding to the gas turbine.

According to another embodiment, which can also be provided as a development, it is envisaged that the fluidic connection between the water-steam circuit and the heat accumulator at the water-steam circuit exists at a heat recovery steam generator, in particular in the region of a medium-pressure section of the heat recovery steam generator. Through suitable extraction of water in the region of the heat recovery steam generator, water can be extracted at what are sometimes different temperature and pressure levels, with the result that said water can also be fed in subsequently for possible mixing of different fractions at different pressures and different temperature levels in a manner suitable for the operation of the gas power plant according to the embodiment.

Moreover, extraction of heat in the region of the medium-pressure section did not reduce the power that could be achieved with the gas turbine plant to such an extent as if water had been extracted in the region of a high-pressure section, for example.

According to another embodiment of the invention, it is envisaged that the container is embodied as a pressurized water container. To this extent, the water extracted from the water-steam circuit can be fed directly to the pressurized water container, for instance, in order to be temporarily stored there for a time in the manner of a heat accumulator. The water temporarily stored in this way is then available again at a suitable pressure and at a suitable temperature level for feeding to the gas turbine to increase the power. In the pressurized container which contains water at increased temperature and increased pressure, there is typically a two-phase mixture of water in liquid form and steam. The extraction of steam, which is then fed to the gas turbine, can also take place on the upper side of the pressurized container. The extraction of steam then results in additional evaporation within the pressurized container, thereby causing the temperature and the pressure in the pressurized container to fall. The extraction of steam therefore results in discharging of the heat accumulator.

According to another embodiment of the invention, it is envisaged that the heat accumulator is designed as a sensible heat accumulator and/or as a latent heat accumulator and/or as a thermochemical heat accumulator. These forms of the heat accumulators make it possible to provide a suitable heat accumulator at low cost and without high investment costs.

According to a first embodiment of the method according to the invention, it is envisaged that the step of transferring heat from the water-steam circuit to the heat accumulator is included in the step of transferring heat from the heat accumulator to the container. To this extent, the heat can be fed directly from the water-steam circuit to the heat accumulator by supplying the container with water from the water-steam circuit for temporary storage, for instance.

It is furthermore advantageous that the step of transferring water from the container to the gas turbine takes place later in time than the other steps, in particular at a time of increased power output by the gas turbine in the case of increased demand for electric power from a power supply network. To this extent, the gas turbine plant is particularly supplied with water from the container to increase the power when there is increased demand for electrical power from the power supply network. This is the case especially when the renewable energy sources, for instance, cannot make available sufficient electrical energy.

The invention will be explained below by means of individual illustrative embodiments, as represented in the figures. It should be noted here that the embodiments shown in the figures are to be taken only as schematic and do not represent a restriction as regards the ways in which the invention can be embodied.

It should furthermore be noted that the components provided with the same reference signs have a comparable technical effect.

It should likewise be noted that the invention is claimed in accordance with the embodiments described below and in any combination of individual components thereof or subassemblies of said embodiments the invention to the extent that said combination falls within the present inventive concept.

### BRIEF DESCRIPTION OF THE DRAWINGS

In the drawings:

FIG. 1 shows a first embodiment of the invention in a schematic circuit diagram.

FIG. 2 shows another embodiment of the invention in a schematic circuit diagram;

FIG. 3 shows another embodiment of the invention in a schematic functional view;

FIG. 4 shows a graphical representation of the change in the output power of a gas turbine plant according to the embodiment and of an associated change in the quantity of heat extracted as a function of the steam quantity extracted at a medium-pressure level.

FIG. 5 shows a graphical representation of the change in the output power of a gas turbine plant according to the embodiment and of the associated change in the quantity of heat absorbed as a function of the quantity of steam fed to the gas turbine.

FIG. 6 shows a first embodiment of the method according to the invention in the form of a flow diagram.

### DETAILED DESCRIPTION OF INVENTION

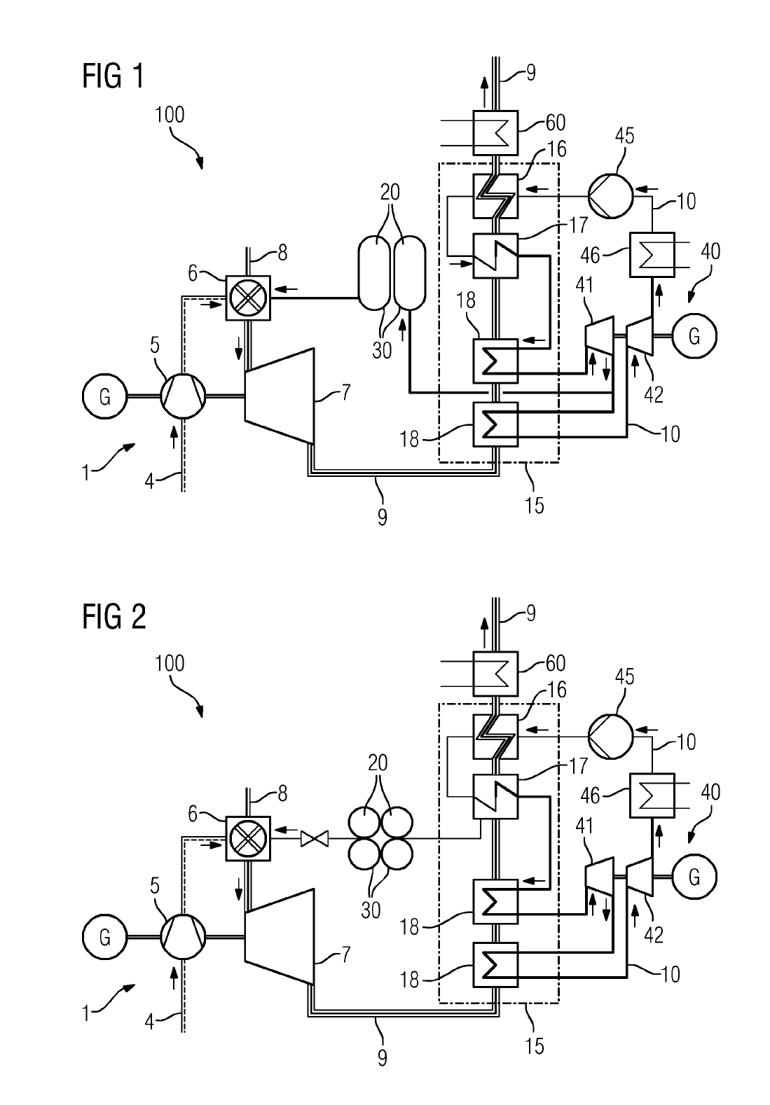

FIG. 1 shows a schematic circuit diagram of a first embodiment of a gas turbine plant 100 according to the invention. It comprises a gas turbine 1 which, for its part, again has a compressor 5, a combustion chamber 6 and an expander 7 (turbine). During operation of the gas turbine 1, air 4 is drawn in through the compressor 5 and compressed to an increased pressure level. This air 4 compressed in this way is fed to the combustion chamber 6 for the combustion of fuel 8. Owing to the combustion conditions in the combustion chamber 6, an operation-specific pressure and temperature level are established. The exhaust gas from this combustion is fed to the expander 7, in which thermal expansion takes place while, at the same time, the work output of the expanding gas is used in a suitable form to generate power by means of the generator (G).

According to the embodiment, the exhaust gas 9 discharged from the gas turbine is fed to a heat recovery steam generator 15, which has a number of different conditioning sections 16, 17, 18. As it flows through the heat recovery steam generator 15, the exhaust gas 9 releases its heat initially to two conditioning sections 18 connected in series, which are designed as superheaters, then to a conditioning section 17, which is designed as an evaporator, and, following this, to a conditioning section 16, which is designed as an economizer.

Like the overall heat recovery steam generator 15, the three conditioning sections 16, 17, 18 are included in a water-steam circuit 10, which also has a steam turbine 40 for power generation. For its part, the steam turbine 40 has a low-pressure turbine 42 and a high-pressure turbine 41, which are coupled in a suitable way and can each drive or jointly drive a generator (G) for power generation.

To assist or produce the flow of the water carried in the water-steam circuit 10, the water-steam circuit 10 can furthermore have a pump 45. Moreover, the water-steam circuit 10 has a condenser 46 downstream of the steam turbine 40.

After heat transfer has taken place from the exhaust gas 9 of the gas turbine 1 as it flows through the heat recovery steam generator 15, another condenser 60 can be provided downstream of the heat recovery steam generator 15 to recover water from the exhaust gas 9, for example, said condenser furthermore having a suitable collecting container for the water separated out.

According to the embodiment, water and heat are furthermore extracted from the water-steam circuit 10 and can be fed to a heat accumulator 20. According to the embodiment, the water and the heat are extracted between the high-pressure turbine 41 and the low-pressure turbine 42 of the water-steam circuit 10. Depending on the embodiment, the extraction of water can take place by means of a heat exchanger (not shown specifically), or the extraction of heat can take place directly by means of a suitable branch line. The heat and the water are fed to the heat accumulator 20 which, according to the embodiment, likewise comprises a container 30, which is suitable for storing water. In particular, the container 30 is suitable for temporarily storing water from the water-steam circuit 10 under pressure and in a temperature-insulated manner, wherein the heat in the water can thus simultaneously be stored temporarily in the heat accumulator 20. For example, water can be extracted at a pressure level of 30 bar after the high-pressure turbine 41 of the steam turbine 40 and stored temporarily at this pressure in the container 30 of the heat accumulator 20.

If there is then an increased power demand from the public power supply networks, the water can be taken from the container 30 and fed to the combustion chamber 6 of the gas turbine 1. As an alternative, feeding the water to the compressor 5 is also possible, for example. According to the embodiment, the combustion chamber 6 is operated at a pressure level of about 20 bar during the operation of the gas turbine 1. If the water extracted from the water-steam circuit 10 is extracted at a pressure level of 30 bar, for instance, and stored temporarily in the container 30, water at a pressure level corresponding at least to the combustion chamber pressure level in the combustion chamber 6 is available at a later time, even after possible energy losses during the storage period. Before being fed to the combustion chamber 6, the water should be additionally depressurized by means of a flash valve (not shown specifically), ensuring that advantageous phase separation of the water can take place and that only steam is fed to the gas turbine 1.

However, the extraction of water from the water-steam circuit 10 after the high-pressure turbine 41, as shown, is only one of numerous possibilities for extracting water at a suitable temperature and a suitable pressure level for subsequent further use to increase the power of the gas turbine 1. In the case of a “three-pressure boiler”, extraction of steam after the high-pressure turbine is suitable, for example, while, in the case of a two-pressure boiler, steam can be extracted between the high-pressure and a low-pressure turbine, for example. Direct extraction of water in liquid form from steam drums at different pressure levels is also possible.

FIG. 2 shows another embodiment of the gas turbine plant 100 according to the invention, which differs from the embodiment shown in FIG. 1 only in that the heat extracted from the water-steam circuit 10 or the water extracted from the water-steam circuit 10 is extracted in the region of an evaporator 17 or a steam drum of the heat recovery steam generator 15 and fed to the heat accumulator 20. The water extracted can be hot water at a pressure level of 25-35 bar, for example. This hot water, in turn, is stored for suitable heat extraction in the heat accumulator 20. A particular option is an embodiment of the heat accumulator 20 in which the container 30 is comprised by the heat accumulator 20, thus allowing water extracted from the water-steam circuit 10 to be stored for heat storage in the container 30. Extraction of the water at the heat recovery steam generator 15 can take place at the steam drum, for example.

The advantage with this embodiment is that the container 30 can be of a design similar to a steam drum, for example, for which reason this component can be provided easily and without further development costs. It is furthermore envisaged that the water is additionally depressurized by means of a flash valve (not shown specifically) before being fed to the combustion chamber 6, allowing advantageous phase separation of the water to take place, and that only steam is fed to the gas turbine 1.

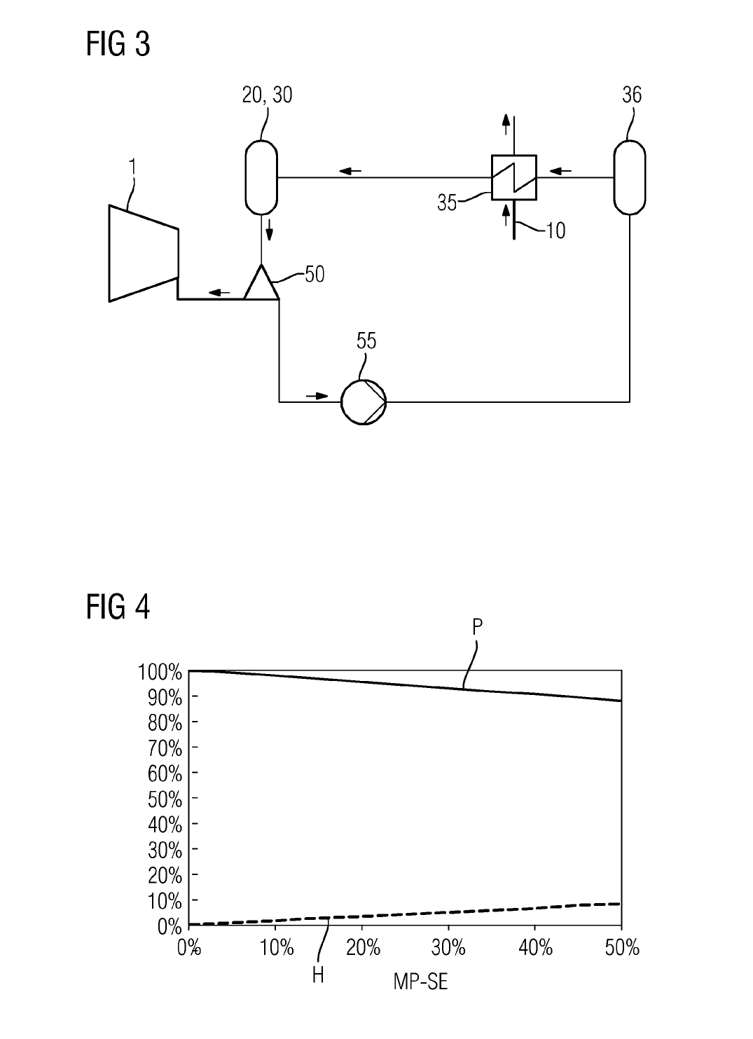

FIG. 3 shows another embodiment of the invention in a schematic functional view. According to the embodiment, heat is extracted from the water-steam circuit 10 and stored temporarily in the heat accumulator 20. The heat accumulator 20 once again comprises the container 30 for temporarily storing water, which water can be fed to the gas turbine 1 when required. The container 30 is designed as a pressurized water accumulator, for example.

Here, the heat exchanger 35 is used for thermal coupling of the water-steam circuit 10 to another circuit (not provided with a reference sign in the present case), into which the container 30 or heat accumulator 20 is incorporated and which likewise has water as a circulating medium. During operation, the heat from steam or superheated steam from a medium-pressure turbine or a medium-pressure section of the heat recovery steam generator 15 can be used, for instance, wherein this heat on water is introduced into the circuit into which the container 30 or heat accumulator 20 is incorporated. Before being depressurized by means of a flash valve 50, the water conditioned in this way is stored temporarily in the container 30 or heat accumulator 20. After depressurization of the water by means of the flash valve 50, there is a pressure reduction and cooling due to evaporation. In this case, steam at a pressure level of 20 bar can be extracted selectively for feeding to the gas turbine 1, for example. The liquid water which is formed at the same time during depressurization by means of the flash valve 50 can be fed back once again to another accumulator 36 at the same pressure level of 20 bar, for example. In this case, the liquid water fed back in this way can be mixed with further make-up water.

According to the embodiment, heat can thus be transferred from the water-steam circuit 10 to circulating storage medium, in the present case water, by means of the heat exchanger 35, which water is then stored temporarily in the container 30 or heat accumulator 20. According to the embodiment, water can thus also be heated to a temperature which is very close to the evaporation temperature. The pressurized water conditioned in this way is then stored in the container 30 or heat accumulator 20 to allow subsequent extraction. As an alternative, it is also possible for the water extracted from a medium-pressure section to be temporarily stored directly in suitable pressurized containers 30 of the heat accumulator 20 for subsequent extraction.

The extraction of heat or water from the water-steam circuit 10 or from the heat recovery steam generator 15 influences the operation of the gas turbine plant 100, in particular electrical output power. In order to clarify this degree of influence more specifically, the applicant has carried out suitable circuit simulations by way of example. A gas turbine plant 100 of the kind illustrated, for example, in FIGS. 1 and 2 served as a basis for the circuit simulations. It has been found here that, with increasing extraction of water (steam) from the water-steam circuit 10, the power P of the gas turbine plant falls. This behavior is illustrated in detail in FIG. 4.

FIG. 4 shows a graphical representation of the change in the relative output power P of a gas turbine plant 100 according to the embodiment and of the associated change in the quantity of heat H extracted as a function of the quantity of steam extracted at a medium-pressure level (typical pressure range 15-40 bar). The quantity of steam corresponds to the percentage of medium-pressure steam which is extracted from the water-steam circuit 10 (MP-SE: medium pressure—steam extraction). This fall in the electrical output power P of the gas turbine plant 100 is substantially correlated in the range shown with the extracted quantity of heat of the steam (H) extracted in the region of a medium-pressure section. Here, only a power loss of about 12% of the output power P of the gas turbine plant 100 need be expected here, even when 50% of the heat of the steam is extracted. This power loss can be justified in order to be able subsequently to achieve a time-delayed increase in power when the steam thus extracted is fed to the gas turbine 1 after suitable temporary storage. The increase in the electrical output power P of the gas turbine plant 100 which occurs in this case is shown in FIG. 5, for example.

FIG. 5 shows a graphical representation of the change in the relative output power P of a gas turbine plant 100 according to the embodiment and of the associated change in the quantity of heat H absorbed as a function of the quantity of steam fed to the gas turbine. In this case, the quantity of steam is related to the proportion of the fuel mass flow (STIG-FR: STIG flow rate). It can be seen here that, after steam is fed in, there is an increase in the electrical power P produced by the gas turbine 1. If the steam mass flow accounts for about 300% of the fuel mass flow fed in, for example, there is already an increase in power of about 20%.

Through selective extraction of heat or water from the water-steam circuit 10 at a first point in time and selective feeding of water, e.g. as steam, having this heat to a gas turbine at another, subsequent, second point in time, improved flexibility of gas turbine operation can be accomplished.

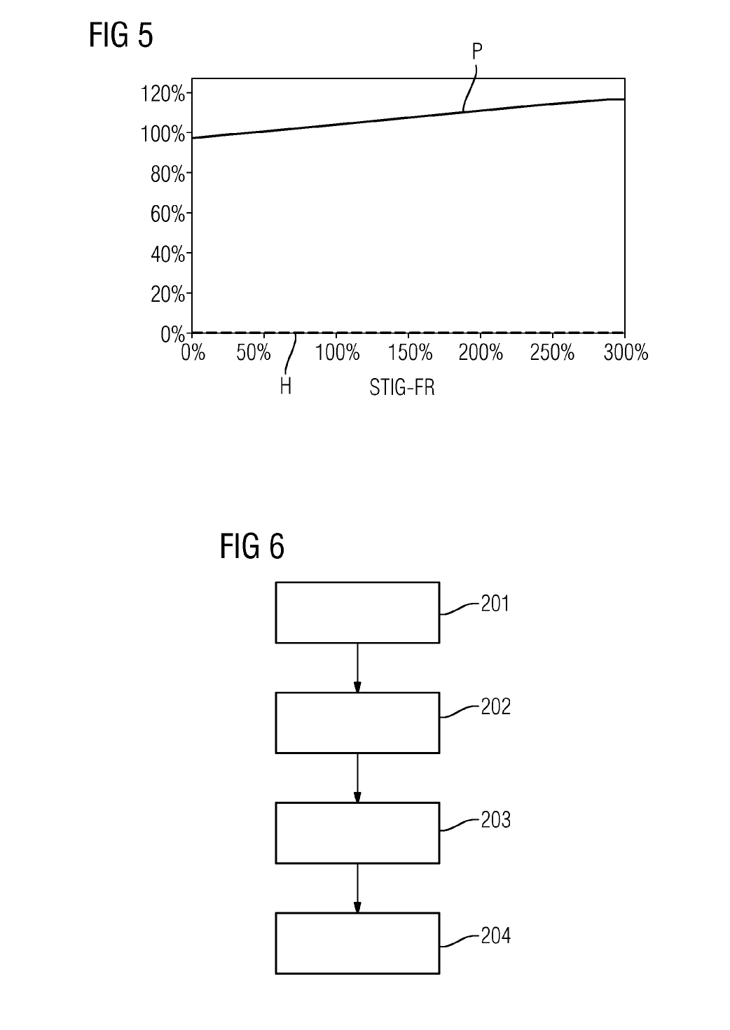

FIG. 6 shows a first embodiment of the method according to the invention for the flexible operation of a gas turbine plant described above, which comprises the following steps:—operating the gas turbine and discharging the exhaust gas from the latter and transferring heat to the water-steam circuit for steam generation (first method step 201);—transferring heat from the water-steam circuit to the heat accumulator (second method step 202);—transferring heat from the heat accumulator to the container (third method step 203);—transferring water from the container to the gas turbine, in particular to the combustion chamber of the gas turbine, to increase power during operation of the gas turbine (fourth method step 204).

Further embodiments will be found in the dependent claims.

1.-13. (canceled)

14. A gas turbine plant comprising:
a gas turbine, which has a compressor, a combustion chamber and an expander,
a water-steam circuit which is thermally connected to the gas turbine such that, during the operation of said gas turbine, the waste gas discharged therefrom transfers heat to the water-steam circuit in order to generate steam,
wherein the water-steam circuit is further thermally connected to a heat accumulator, which in turn is thermally connected to a container for storing water, and
wherein the container is fluidically coupled to the gas turbine such that water can be supplied from the container to the gas turbine during the operation of the gas turbine in order to increase power output,
a flash valve connected between the container and the gas turbine, said valve adapted to reduce the pressure of the water taken from the container to a lower pressure level,
wherein the flash valve is further adapted to separate out steam in order to feed the steam selectively to the gas turbine without a liquid component, likewise separated out, of the water which has been depressurized in this way.

15. The gas turbine plant as claimed in claim 14,
wherein the heat accumulator comprises or is the container.

16. The gas turbine plant as claimed in claim 14,
wherein the water-steam circuit comprises a heat recovery steam generator, which is connected thermally and fluidically to the heat accumulator.

17. The gas turbine plant as claimed in claim 14,
wherein the water-steam circuit has a steam turbine, which is connected thermally and fluidically to the heat accumulator.

18. The gas turbine plant as claimed in claim 14,
wherein the water-steam circuit and the heat accumulator are connected not only thermally but also fluidically.

19. The gas turbine plant as claimed in claim 18,
wherein water exchanged between the water-steam circuit and the heat accumulator is adapted to be stored temporarily in the container.

20. The gas turbine plant as claimed in claim 18,
wherein the fluidic connection between the water-steam circuit and the heat accumulator at the water-steam circuit is produced at a location at which the steam pressure prevailing during regular operation of the gas turbine plant corresponds at least to the pressure in the combustion chamber of the gas turbine during regular operation.

21. The gas turbine plant as claimed in claim 18,
wherein the fluidic connection between the water-steam circuit and the heat accumulator at the water-steam circuit exists at a heat recovery steam generator.

22. The gas turbine plant as claimed in claim 14,
wherein the container comprises as a pressurized water container.

23. The gas turbine plant as claimed in claim 14,
wherein the heat accumulator comprises a sensible heat accumulator and/or a latent heat accumulator and/or a thermochemical heat accumulator.

24. A method for the flexible operation of the gas turbine plant as claimed in claim 14, comprising:
operating the gas turbine and discharging the exhaust gas from the gas turbine and transferring heat to the water-steam circuit for steam generation;
transferring heat from the water-steam circuit to the heat accumulator;
transferring heat from the heat accumulator to the container;
transferring water from the container to the gas turbine to increase power during operation of the gas turbine.

25. The method as claimed in claim 24,
wherein the step of transferring heat from the water-steam circuit to the heat accumulator is included in the step of transferring heat from the heat accumulator to the container.

26. The method as claimed in claim 24,
wherein the step of transferring water from the container to the gas turbine takes place later in time than the other steps.

27. The gas turbine plant as claimed in claim 14,
wherein the container is fluidically coupled to the combustion chamber of the gas turbine.

28. The gas turbine plant as claimed in claim 21,
wherein the fluidic connection between the water-steam circuit and the heat accumulator at the water-steam circuit exists in the region of a medium-pressure section of the heat recovery steam generator.

29. The method as claimed in claim 24,
wherein the step of transferring water from the container to the gas turbine comprises transferring to the combustion chamber of the gas turbine to increase power during operation of the gas turbine.

30. The method as claimed in claim 24,
wherein the step of transferring water from the container to the gas turbine takes place at a time of increased power output by the gas turbine in the case of increased demand for electric power from a power supply network.
